(19) United States
(12) Patent Application Publication
(10) Pub. No.: US 2024/0422546 A1
(43) Pub. Date: Dec. 19, 2024

(54) LOG DETERMINATION DEVICE, LOG DETERMINATION METHOD, LOG DETERMINATION PROGRAM, LOG DETERMINATION SUPPORT DEVICE, LOG DETERMINATION SUPPORT METHOD, AND LOG DETERMINATION SUPPORT PROGRAM

(71) Applicant: DENSO CORPORATION, Kariya-city (JP)

(72) Inventors: Ryosuke MURAKAMI, Kariya-city (JP); Tokuya INAGAKI, Kariya-city (JP); Tatsuro KAWAKAMI, Kariya-city (JP)

(21) Appl. No.: 18/731,452

(22) Filed: Jun. 3, 2024

(30) Foreign Application Priority Data
Jun. 13, 2023 (JP) 2023-097145

(51) Int. Cl. H04W 12/121; H04W 12/126

(52) U.S. Cl. CPC H04W 12/121; H04W 12/126

(57) ABSTRACT

By a log determination device, a log determination method, a non-transitory computer-readable storage medium storing a log determination program, a log determination support device, a log determination support method, or a non-transitory computer-readable storage medium storing a log determination support program, a risk degree of attack reception by an electronic control system mounted on a mobile object is determined, whether the electronic control system has received the attack is determined.

### CROSS REFERENCE TO RELATED APPLICATION

The present application claims the benefit of priority from Japanese Patent Application No. 2023-097145 filed on Jun. 13, 2023. The entire disclosure of the above application is incorporated herein by reference.

### TECHNICAL FIELD

The present disclosure mainly relates to a log determination device configured to determine a log indicating an abnormality that has occurred in an electronic control system mounted on a mobile object such as an automobile, a method and program executed by the log determination device, and a log determination support device configured to support log determination by the log determination device, and a method and a program executed by the log determination support device.

### BACKGROUND

In recent years, technologies for driving assistance and automated driving, including V2X such as vehicle-to-vehicle communication and roadside-to-vehicle communication, have been attracting attention. As a result, a vehicle has a communication function, and a so-called connectivity of the vehicle is progressing. As a result, a probability that a vehicle may receive a cyber attack called unauthorized access is increasing. Therefore, it may be necessary to analyze the cyber attack on vehicles and to construct countermeasures against the cyber attack.

There are various technologies for detecting abnormalities occurring in vehicles and analyzing the cyber attack based on the detected abnormalities. In a comparative example, detected abnormality data is collected, and a combination of items in which the abnormalities are detected is compared with an abnormality detection pattern specified in advance for each attack. Then, the type of attack corresponding to the abnormality is specified.

### SUMMARY

By a log determination device, a log determination method, a non-transitory computer-readable storage medium storing a log determination program, a log determination support device, a log determination support method, or a non-transitory computer-readable storage medium storing a log determination support program, a risk degree of attack reception by an electronic control system mounted on a mobile object is determined, whether the electronic control system has received the attack is determined.

### BRIEF DESCRIPTION OF THE DRAWINGS

FIG. 1 is a diagram showing an arrangement of a log determination device and a log determination support device and a relationship with related devices according to each embodiment.

FIG. 2A is an explanatory diagram for illustrating a relationship between the log determination device and an electronic control system according to each embodiment.

FIG. 2B is an explanatory diagram for illustrating a relationship between the log determination device and the electronic control system according to each embodiment.

FIG. 3 is an explanatory diagram for illustrating a configuration example of the electronic control system according to each embodiment.

FIG. 4 is a block diagram showing a configuration example of a log determination device according to a first embodiment.

FIG. 5 is a diagram for illustrating a risk map according to the first embodiment.

FIG. 6 is a diagram for illustrating an example of a prediction table according to the first embodiment.

FIG. 7A is a diagram for illustrating an example of the prediction table according to the first embodiment.

FIG. 7B is a diagram for illustrating an example of the prediction table according to the first embodiment.

FIG. 8A is a diagram for illustrating an example of the prediction table according to the first embodiment.

FIG. 8B is a diagram for illustrating an example of the prediction table according to the first embodiment.

FIG. 9 is a diagram for illustrating the operation of the log determination device according to the first embodiment.

FIG. 10 is a diagram for illustrating the operation of the log determination device according to the first embodiment.

FIG. 11 is a block diagram showing a configuration example of the log determination device according to a second embodiment.

FIG. 12 is a block diagram showing a configuration example of a log determination support device according to the second embodiment.

FIG. 13 is a diagram for illustrating operations of the log determination device and the log determination support device according to the second embodiment.

FIG. 14 is a block diagram showing a configuration example of the log determination device according to a third embodiment.

FIG. 15 is a block diagram showing a configuration example of the log determination support device according to the third embodiment.

FIG. 16 is a diagram for illustrating operations of the log determination device and the log determination support device according to the third embodiment.

FIG. 17 is a diagram for illustrating a configuration example of the log determination support device according to a modification of the third embodiment.

### DETAILED DESCRIPTION

The present inventors have found the following difficulties as a result of detailed study. The comparative example uniformly executes a cyber attack detection process based on abnormal data. However, depending on the situation of the vehicle, the vehicle may be more or less susceptible to the cyber attack, or the impact of a cyber attack may be large or small. Particularly, when a vehicle is in a situation where the impact of an attack is large, it is desirable to detect the attack with high sensitivity and respond to the attack. Therefore, it is necessary to reliably execute a cyber attack detection process according to the vehicle situation.

Therefore, examples of the present disclosure provide a device, a method, and a computer-readable non-transitory storage medium that execute an attack detection process according to a situation of a vehicle by dynamically changing a determination criterion used in the cyber attack detection process.

According to one example embodiment of the present disclosure, a log determination device is mounted on a mobile object, and includes: a risk determination unit configured to determine a risk degree of attack reception by an electronic control system mounted on the mobile object, based on a state of the mobile object; a determination criterion setting unit configured to set a determination criterion that is a criterion for determining whether the electronic control system has received an attack; a log acquisition unit configured to acquire ab abnormality log generated by a sensor of the electronic control system when the sensor has detected an abnormality; an attack determination unit configured to determine whether the electronic control system has received the attack using the determination criterion set by the determination criterion setting unit and the abnormality log; and a determination result transmitter configured to transmit a determination result by the attack determination unit to an outside of the mobile object.

According to another example embodiment of the present disclosure, a log determination support device is connected to a log determination device mounted on a mobile object and located outside the mobile object, and includes: a mobile object information receiver configured to receive mobile object information indicating a state of the mobile object from the log determination device; a risk determination unit configured to determine a risk degree of attack reception by an electronic control system mounted on the mobile object, based on the mobile object information; a determination criterion determination unit configured to determine a determination criterion that is a criterion for determining whether the electronic control system has received an attack; and a criterion transmitter configured to transmit the determination criterion determined by the criterion determination unit to the log determination device. The log determination device determines whether the electronic control system has received the attack using the attack the determination criterion transmitted from the log determination support device and an abnormality log generated by a sensor of the electronic control system when the sensor has detected an abnormality log.

According to the above configuration, the log determination device of the present disclosure is possible to execute the attack detection process according to the degree of risk of a vehicle receiving the cyber attack by dynamically setting a determination criterion of whether the vehicle has received the attack depending on the degree of risk of the vehicle receiving the cyber attack.

Hereinafter, embodiments of the present disclosure will be described with reference to the drawings.

### 1. Configuration as Prerequisite of Each Embodiment

(1) Arrangement of Log Determination Device and Relationship with Related Device

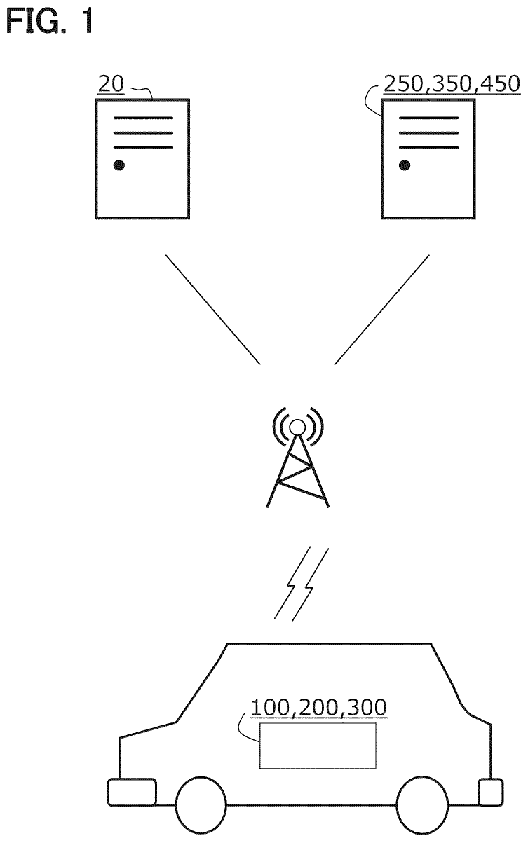

FIG. 1 is a diagram for illustrating an arrangement of a log determination device according to each embodiment. As shown in FIG. 1, a log determination device 100, a log determination device 200, or a log determination device 300 (hereinafter referred to collectively as the log determination device 100, or the like) is “mounted on” a vehicle that is a “mobile object.”

Here, the “mobile object” refers to a movable object, and a movement speed is arbitrary. A case where the mobile object is stopped is also included. Examples of the mobile object include, but are not limited to, an automobile, a motorcycle, a bicycle, a pedestrian, a ship, an aircraft, and an object mounted thereon. The term “mounted” includes not only a case in which an object is directly fixed to the vehicle but also a case in which an object is moved together with the vehicle although the object is not fixed to the vehicle. Examples thereof include one carried by a person in the vehicle, and one mounted on a load placed in the vehicle.

The log determination device 100 and the like are connected to an external device 20 provided outside the vehicle via a communication network. The external device 20 is a device that acquires log determination results by the log determination device 100 and the like and performs detailed analysis of cyber attacks, and is implemented by, for example, a server device, an SOC (Security Operation Center), or the like.

The log determination device 100, the external device 20, and the like are connected via a communication network such as a wireless communication system such as IEEE 802.11 (Wi-Fi (registered trademark)), IEEE 802.16 (WiMAX (registered trademark)), W-CDMA (Wideband Code Division Multiple Access), HSPA (High Speed Packet Access), LTE (Long Term Evolution), LTE-A (Long Term Evolution Advanced), 4G, or 5G. Alternatively, dedicated short range communication (DSRC) can be used. When the vehicle is parked in a parking lot or accommodated in a repair shop, a wired communication method can be used instead of the wireless communication method. For example, a local area network (LAN), the Internet, or a fixed telephone line can be used.

The log determination device 100 and the like are further connected to a log determination support device 250, a log determination support device 350, or a log determination support device 450 (hereinafter, these are collectively referred to as the log determination auxiliary device 250, and the like). The log determination support device 250 and the like are devices for supporting the log determination device in a second embodiment 2, a third embodiment, or a modification thereof, which will be described later. The log determination device 100, the log determination support device 250, and the like are connected using the same communication method as the communication method between the log determination device 100 or the like and the external device 20.

Note that in each embodiment described below, the external device 20 and the log determination support device 250 and the like are shown as separate devices, but the external device 20 and the log determination support device 250 and the like may be the same device.

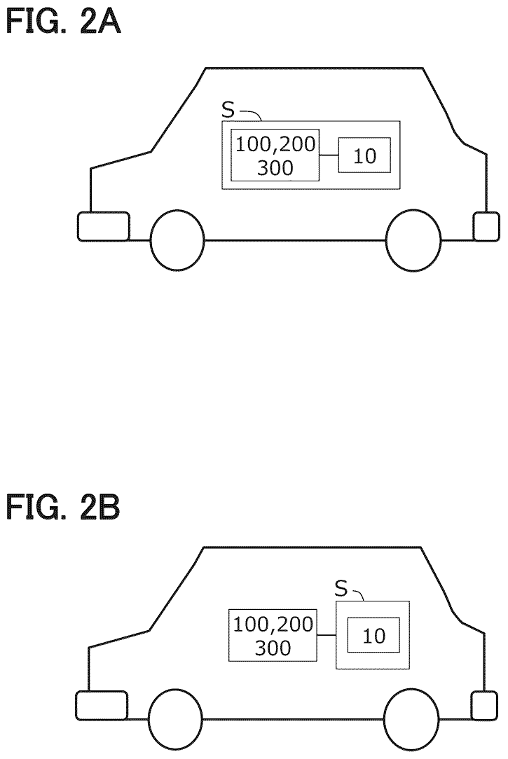

FIGS. 2A and 2B are diagrams for illustrating the arrangement of the log determination device 100 and the like and the electronic control system S of each embodiment. The log determination device 100 or the like according to each embodiment is “connected” to a plurality of “electronic control units” 10 (hereinafter referred to as ECUs) constituting the electronic control system S.

FIG. 2A shows a case where the log determination device 100 and the like are provided inside the electronic control system S, and FIG. 2B shows a case where the log determination device 100 is provided outside the electronic control system S. In the cases of FIGS. 2A and 2B, the log determination device 100 or the like is connected to the plurality of ECUs 10 via an in-vehicle communication network such as a controller area network (CAN) or a local interconnect network (LIN). Alternatively, connection may be made by using any communication method, whether wired or wireless, such as Ethernet (registered trademark), Wi-Fi (registered trademark), and Bluetooth (registered trademark).

### (2) Configuration of Electronic Control System S

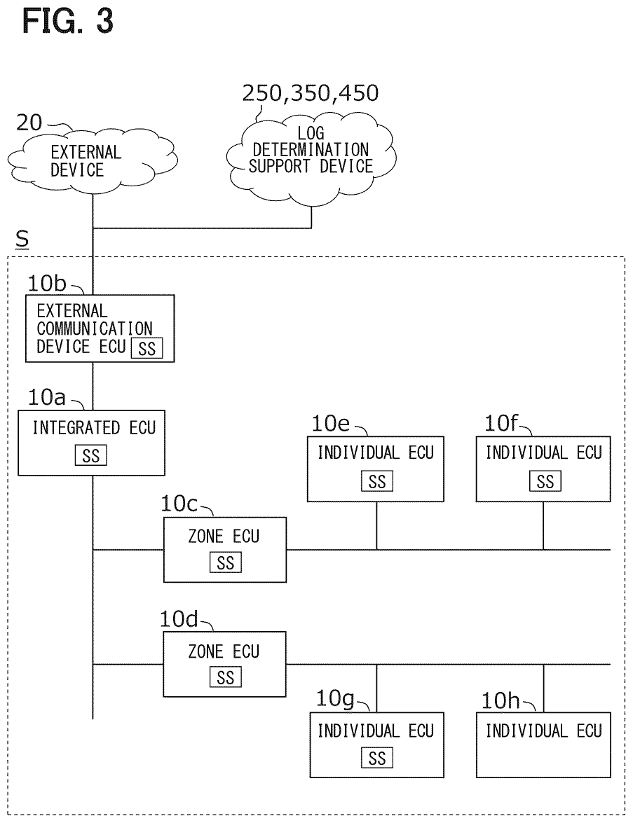

FIG. 3 is a diagram showing a configuration example of the electronic control system S. The electronic control system S includes the plurality of ECUs 10 and an in-vehicle network connecting the ECUs 10. Although FIG. 3 illustrates eight ECUs (ECUs 10a to 10h), it is obvious that the electronic control system S may include any number of ECUs. In the following description, the ECU 10 and the ECUs 10 are described comprehensively for a single or multiple electronic control units, and the ECU 10a, ECU 10b, ECU 10c, . . . are described when individual electronic control units are specifically described.

The electronic control system S shown in FIG. 3 includes an integrated ECU 10a, an external communication ECU 10b, zone ECUs (10c, 10d), and individual ECUs (10e to 10h). Each ECU 10 is connected via an in-vehicle communication network similar to the communication method between the log determination device 100 and the like and the plurality of ECUs 10.

The integrated ECU 10a has a function of controlling the entire electronic control system S and a gateway function of mediating communication between the ECUs. The integrated ECU 10a may be referred to as a gateway ECU (G-ECU) or a mobility computer (MC). The integrated ECU 10a may be a relay device or a gateway device.

The external communication ECU 10b is an ECU including a communication unit that communicates with the external device 20 provided outside the vehicle and the log determination support device 250 and the like. The communication system used by the external communication ECU 10b is the wireless communication system or the wired communication system described above. In order to implement multiple communication systems, multiple external communication ECUs 10b may be provided. Instead of providing the external communication ECU 10b, the integrated ECU 10a may include the function of the external communication ECU 10b.

Each of the zone ECUs (10c, 10d) is an ECU having a gateway function that is appropriately arranged based on a location where the individual ECU is disposed or a function thereof. For example, the zone ECU 10c is an ECU having a gateway function of mediating communication between the individual ECU 10e and the individual ECU 10f disposed in front of the vehicle and another ECU 10, and the zone ECU 10d is an ECU having a gateway function of mediating communication between the individual ECU 10g and the individual ECU 10h disposed in rear of the vehicle and another ECU 10.

The individual ECUs (10e to 10h) can be implemented by ECUs having any functions. For example, there are a drive system electronic control unit controlling an engine, a steering wheel, a brake, and the like, a vehicle body system electronic control unit controlling a meter, a power window, and the like, an information system electronic control unit such as a navigation device, or a safety control system electronic control unit performing control for preventing collision with an obstacle or a pedestrian. The ECUs may be classified into a master and a slave instead of being arranged in parallel.

In the electronic control system S of FIG. 3, a security sensor is mounted in each ECU 10 other than the ECU 10h (abbreviated as SS in the drawing). As described above, it is not necessary for the security sensors to be mounted on all the ECUs 10 constituting the electronic control system S. The security sensor monitors operations of the ECUs and communication between the ECUs, and generates a log when any abnormality is detected. Although each ECU is illustrated as being equipped with one security sensor in FIG. 3, each ECU may be equipped with a plurality of security sensors as described later. Hereinafter, the log generated by the security sensor will be referred to as an abnormality log. The abnormality log generated by the security sensor is transmitted to the log determination device 100 or the like via the in-vehicle network.

In each embodiment, a case where the log determination device 100 and the like are provided inside the electronic control system S and provided in the integrated ECU 10a will be described as an example. However, the log determination device 100 and the like may be provided in the external communication ECU 10b, the zone ECUs (10c, 10d), or the individual ECUs (10e to 10h). When provided in one of the individual ECUs (10e to 10h), it is desirable to use a dedicated ECU for implementing the log determination device 100 and the like.

Note that when, among the ECUs 10 constituting the electronic control system S, an ECU 10 that is not the external communication ECU 10b includes a function such as the log determination device 100, a receiver and a transmitter of the log determination device described later communicate with the external device 20, the log determination support device 250, and the like via the external communication ECU 10b.

### 2. First Embodiment

### (1) Configuration of Log Determination Device 100

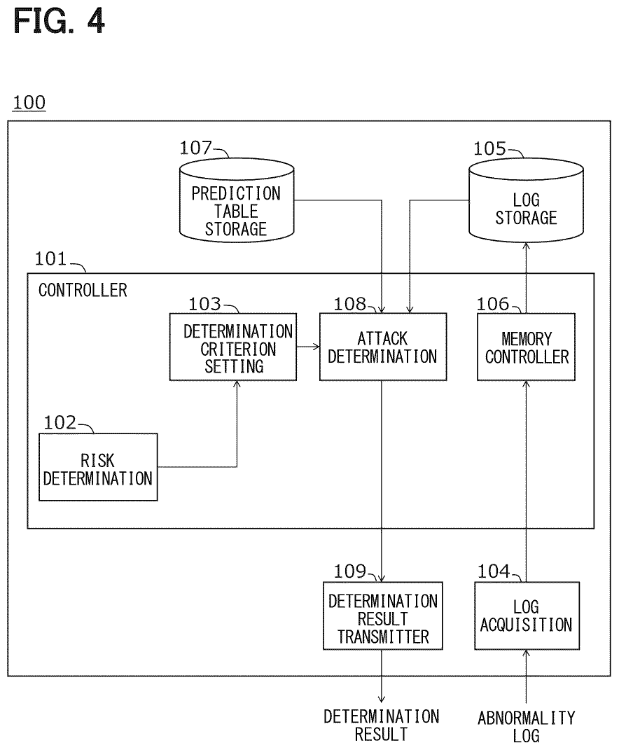

The configuration of the log determination device 100 according to the present embodiment will be described with reference to FIG. 4. The log determination device 100 includes a controller 101, a log acquisition unit 104, a log storage 105, a prediction table storage 107, and a determination result transmitter 109. The controller 101 implements a risk determination unit 102, a determination criterion setting unit 103, a memory controller 106, and an attack determination unit 108 using hardware and/or software.

The risk determination unit 102 determines the “degree of risk” of attack reception by the electronic control system S mounted on the vehicle based on a “state of the mobile object that is the vehicle. The degree of risk may be also referred to as a risk degree.

Here, the “state of the mobile object” includes both the internal state of the mobile object and the external state of the mobile object. In addition, the “risk degree” indicates the cause, target, or result of the risk qualitatively or quantitatively. For example, it indicates the probability that an attack will occur or the degree of damage caused by the attack, and may be expressed in numbers, standardized values, symbols, or sets.

The risk determination unit 102 determines the degree of risk based on a position of the vehicle as the state of the mobile object, for example. The incidence of the cyber attack may vary depending on an area. Therefore, the attack reception risk of the electronic control system S is high in areas where the incidence of cyber attacks is high, and the attack reception risk of the electronic control system S is low in areas where the incidence of cyber attacks is low. Therefore, the risk determination unit 102 determines the attack reception risk of the electronic control system S based on the current position of the vehicle. The position of the vehicle can be acquired from a GPS (not shown) mounted on the vehicle, from an IP address used for communication by the external communication ECU 10b, or from outside the vehicle.

For example, the log determination device 100 stores in advance a risk map showing the risk degree for each area, and the risk determination unit 102 determines the risk degree indicated by the risk map at the current position of the vehicle as the risk degree of the electronic control system S.

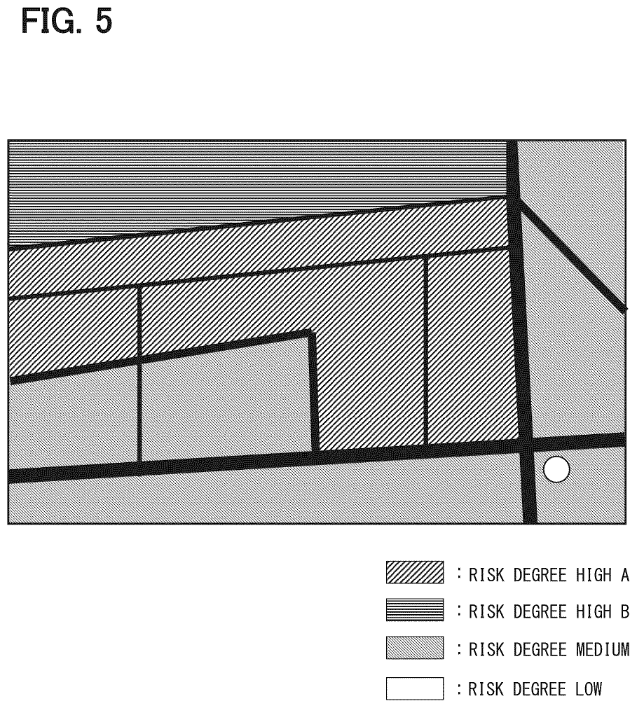

The risk map is a map showing the risk degree for each country, each prefecture, or each range of several meters to several kilometers. FIG. 5 shows an example of the risk map. In the example shown in FIG. 5, the risk degree is classified into three levels, high, medium and low, but the risk degree may be further classified. In the example of FIG. 5, areas with low risk are pinpointed by illustration. For example, the risk degree may be set be low near a dealer or a repair shop. Further, since there are a large number of vehicles in the city, it can be said that there is a high degree of risk in the event that a vehicle malfunctions due to a cyber attack on the electronic control system S. Therefore, the risk degree may be set higher in the city center than in the suburbs. Further, areas such as areas near expressways and intersections may be set to have a higher degree of danger than other areas.

In the risk map shown in FIG. 5, there are two areas where the risk degree is high. One is an area where the risk degree is classified as high A, and the other is an area where the risk degree is classified as high B. For example, the area in which the risk degree is classified as the high A is an area where many attacks against a drive system ECU occur, and the risk degree for the drive system ECU is high. Further, the area in which the risk degree is classified as the high B is an area where many attacks against a vehicle body system ECU occur, and the risk degree for the vehicle body system ECU is high. In this way, even in a case where the risk degree is quantitatively the same, when it is qualitatively different, it may be classified into different areas. Note that the term “the risk degree is qualitatively different” includes not only the case where the targets to be attacked are different as described above, but also the case where the type of attack itself is different.

Note that the risk determination unit 102 may determine the risk degree based on other parameters instead of or in addition to the position of the vehicle. For example, the risk determination unit 102 may determine the risk degree based on the movement speed of the vehicle or whether the vehicle is an automated driving vehicle. When the electronic control system S receives the cyber attack in a state where the movement speed of the vehicle is high, the safety of the vehicle and its occupants is likely to be compromised. Similarly, as compared to when the vehicle is manually controlled by the driver, when the vehicle is automatically traveling and the electronic control system S receives the cyber attack, the safety of the vehicle and its occupants is likely to be compromised. Therefore, it can be said that the risk degree is high when the vehicle is moving at a high speed or when the vehicle is an automated driving vehicle. Therefore, in such a case, the risk determination unit 102 determines that the risk degree is high. The risk determination unit 102 may further determine the risk degree based on other parameters such as the temperature outside the vehicle or the time period in which the vehicle is traveling.

Note that the term “automated driving vehicle” refers to, for example, a vehicle in a state where automated driving is being performed at a level higher than a predetermined level. Therefore, even in a case where a vehicle has an automated driving function, when an occupant is manually driving the vehicle, it does not need to be considered the automated driving vehicle. Further, even in a case where the automated driving function of the vehicle is enabled, when the automated driving level is low (for example, automated driving level 1 that provides driving assistance), the vehicle may not be equivalent to the automated driving vehicle. Further, the risk determination unit 102 may determine the risk degree depending on the automated driving level.

Further, the risk determination unit 102 may determine the risk degree based on risk information acquired from outside the vehicle. For example, the risk determination unit 102 may receive risk information indicating the risk degree of an area where a roadside device is located from the roadside device. In this case, the risk determination unit 102 determines the risk degree indicated by the risk information received from the roadside device as an attack reception risk degree of the electronic control system S.

The determination criterion setting unit 103 determines a determination criterion used as a criterion for determining whether the electronic control system S has been attacked, based on the risk degree determined by the risk determination unit 102, and sets the determined criterion as a determination criterion used by the attack determination unit 108 described later for determining the attack. Details of the criterion set by the determination criterion setting unit 103 will be described later.

The log acquisition unit 104 acquires the abnormality log generated by the security sensor installed mounted on each ECU 10.

The log storage 105 stores the abnormality log acquired by the log acquisition unit 104. The log storage 105 may be an external storage device (hard disk, USB memory, CD/BD, or the like) or an internal storage device (RAM, or the like).

The memory controller 106 controls the log storage 105. For example, when the attack determination unit 108 (described later) determines that an attack has been received, the log storage 105 is controlled to store the abnormality log acquired by the log acquisition unit 104 within a predetermined time before and after the determination.

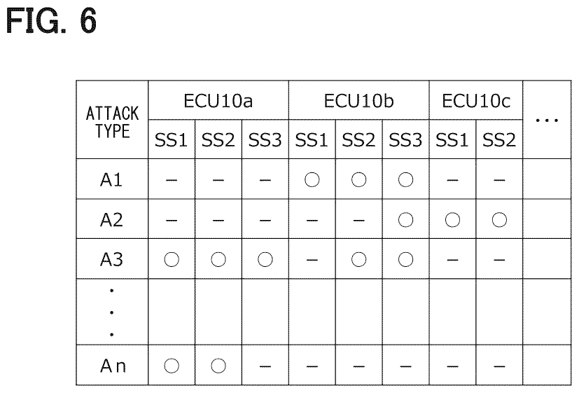

The prediction table storage 107 is a memory that stores a prediction table used for attack determination by an attack determination unit 108, which will be described later. FIG. 6 is a diagram showing an example of a prediction table stored in the prediction table storage 107. The prediction table shows the correspondence relationship between a combination of a plurality of prediction abnormality logs that are predicted to be generated by each security sensor when the electronic control system S receives a specific attack, and the attack type of the specific attack (for example, attack A, attack B, . . . ). The prediction table shown in FIG. 6 shows that, for example, when the electronic control system S receives the attack A, security sensors 1 to 3 mounted on the ECU 10b are predicted to detect the abnormality and generate the abnormality log.

The attack determination unit 108 determines whether the electronic control system S has “received the attack” using the abnormality log acquired by the log acquisition unit 104. The attack determination unit 108 of the present embodiment compares the prediction table stored in the prediction table storage 107 and the abnormality log acquired by the log acquisition unit 104, and determines that the electronic control system S has received the attack when the prediction table includes a combination of a plurality of prediction abnormality logs corresponding to the abnormality logs. For example, when the log acquisition unit 104 has acquired the abnormality log generated by the security sensor 3 of the ECU 10b and the abnormality logs generated by the security sensor 1 and the security sensor 2 of the ECU 10c, these abnormality logs match the combination of prediction abnormality logs of an attack type (A2). Therefore, the attack determination unit 108 determines that the electronic control system S has received the attack (attack type A2).

Here, the case of having “received the attack” includes not only cases where the attack has actually been received, but also cases where there is a possibility that the attack has been received and it can be evaluated that the attack has been received.

Note that the attack determination unit 108 may determine that the attack has been received even when the abnormality log and the combination of the plurality of prediction abnormality logs in the prediction table do not completely match. For example, it may be determined that the attack has been received when the match rate between the abnormality log and the combination of the plurality of prediction abnormality logs is equal to or higher than a threshold value.

The determination result transmitter 109 transmits the determination result by the attack determination unit 108 to the external device 20 located outside the vehicle. The determination result transmitter 109 may transmit a determination result indicating whether the electronic control system S has received the attack. Alternatively, when the attack determination unit 108 determines that the electronic control system S has received the attack, the determination result transmitter 109 may transmit the determination result with the log used for the determination. Further, the determination result transmitter 109 may transmit the determination result to the external device 20 only when the attack determination unit 108 determines that the electronic control system S has received the attack.

Next, the criterion set by the determination criterion setting unit 103 will be described.

The criterion determined and set by the determination criterion setting unit 103 is, for example, the prediction table used by the attack determination unit 108 for determining the attack. In this case, the prediction table storage 107 stores in advance a plurality of prediction tables depending on the risk degree. The determination criterion setting unit 103 sets, as the prediction table used by the attack determination unit 108, in other words, the determination criterion, one prediction table corresponding to the risk degree determined by the risk determination unit 102 among the plurality of prediction tables stored in the prediction table storage 107.

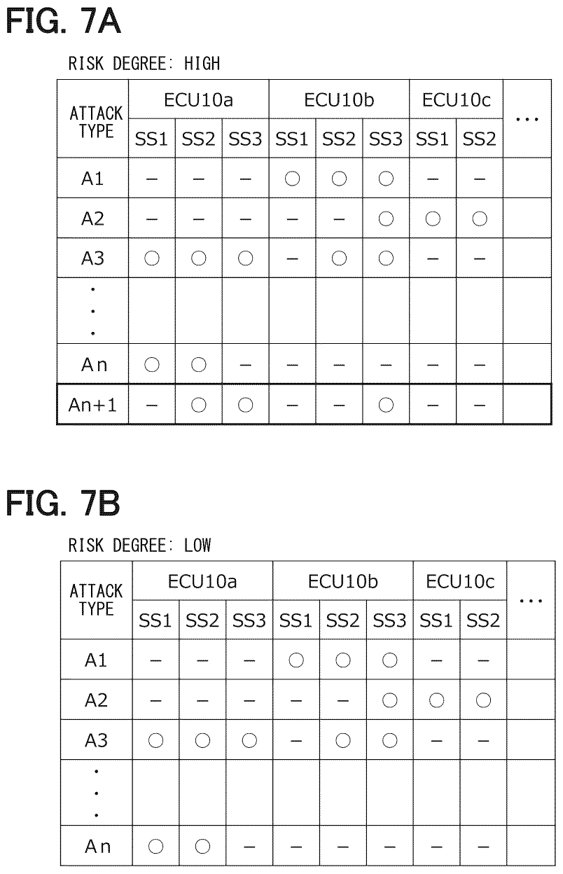

FIGS. 7A and 7B are diagrams showing an example of a prediction table that differs depending on the risk degree. FIG. 7A is a prediction table (corresponding to a “first prediction table”) corresponding to a high risk degree (corresponding to a “first risk degree”). FIG. 7B is a prediction table (corresponding to a “second prediction table”) corresponding to a low risk degree (corresponding to a “second risk degree”). The prediction table shown in FIG. 7A shows combinations of prediction abnormality logs for attack types A1 to An+1. On the other hand, the prediction table shown in FIG. 7B shows combinations of prediction abnormality logs for attack types A1 to An. That is, the prediction table corresponding to the high risk degree has more correspondence relationships between combinations of attack types and prediction abnormality logs than a prediction table corresponding to the low risk degree (in other words, a numerical number of the correspondence relationship in prediction table corresponding to the high risk degree is more than a numerical number of the correspondence relationship in the prediction table with the low risk degree).

When the risk degree is high, in order to minimize the damage caused by the attack, it is desirable to more reliably determine whether the electronic control system S has received the attack without overlooking the attack. Therefore, as shown in FIGS. 7A and 7B, a prediction table is used that can determine more attack types as the risk degree increases.

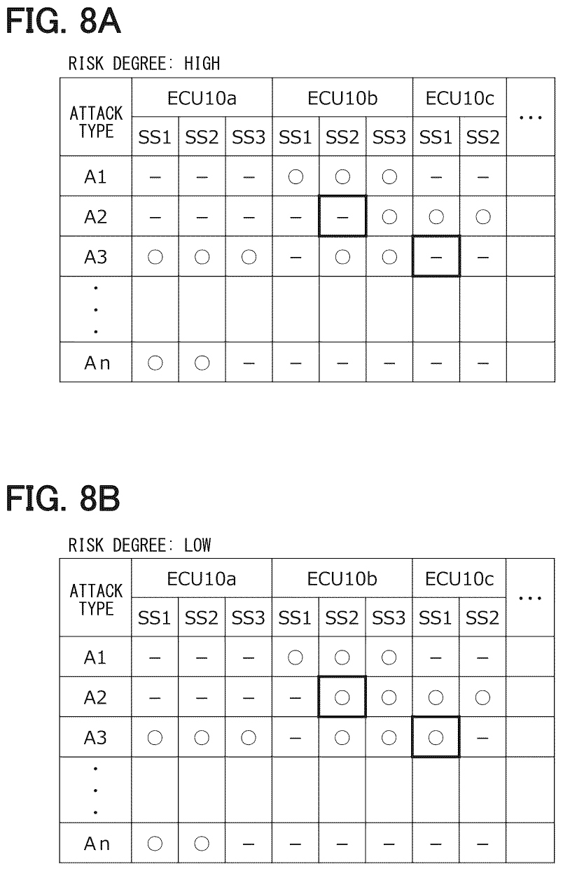

FIGS. 8A and 8B are diagrams showing another example of the prediction table that differs depending on the risk degree. FIG. 8A is a prediction table (corresponding to the “first prediction table”) corresponding to a high risk degree (corresponding to the “first risk degree”). FIG. 8B is a prediction table (corresponding to the “second prediction table”) corresponding to a low risk degree (corresponding to the “second risk degree”). In the example of FIGS. 8A and 8B, the number of attack types that can be determined by the attack determination unit 108 is the same for any degree of risk. However, the number of prediction abnormality logs associated with one attack type is different between FIG. 8A and FIG. 8B. For example, in the prediction table of FIG. 8A, the prediction abnormality logs associated with the attack type A2 are the prediction abnormality logs generated by the security sensor 3 of the ECU 10b and the security sensors 1 and 2 of the ECU 10c. On the other hand, in the prediction table of FIG. 8B, the prediction abnormality logs associated with the attack type A2 are the prediction abnormality logs generated by the security sensors 2 and 3 of the ECU 10b and the security sensors 1 and 2 of the ECU 10c. That is, the number of prediction abnormality logs associated with attack type A2 in the prediction table corresponding to a high risk degree is smaller than the number of prediction abnormality logs associated with attack type A2 in the prediction table corresponding to a low risk degree.

As in the example of FIGS. 7A and 7B, when the risk degree is high, it is desirable to more reliably determine that the attack has been received. Therefore, in the case where the risk is high, a prediction table with a small number of prediction abnormality logs associated with the attack type is used so that the attack can be detected even with a small number of security sensors that detect the abnormality.

In FIGS. 7A, 7B, 8A and 8B, the examples have been described in which different prediction tables are used depending on the risk degree. However, even in a case where the risk degree is the same, different prediction tables may be used when the type of risk is different. For example, in the risk map shown in FIG. 5, different prediction tables may be used for areas classified as high risk A and areas classified as high risk B.

In FIGS. 7A, 7B, 8A and 8B, the case where the criterion set by the determination criterion setting unit 103 is a prediction table has been described as an example, but the determination criterion does not have to be the prediction table. For example, a threshold value of a matching rate between the abnormality log and a combination of the plurality of prediction abnormality logs included in the prediction table may be set as the determination criterion. The attack determination unit 108 determines that the attack has been received when the match rate between the abnormality log and the combination of the plurality of prediction abnormality logs included in the prediction table is “equal to or more than” a threshold value. In this case, when the risk degree is high (corresponding to the “first risk degree”), the determination criterion setting unit 103 sets the threshold, which is the determination criterion so that the match rate is lower than when the risk degree is low (corresponding to the “second risk degree”).

The case of “equal to or more than” described above includes both cases where a first object contains the same value as a second object in comparison and where the first object does not contain the same value as the second object in comparison.

In a case where the match rate threshold becomes low, the attack determination unit 108 determines that the attack has been received even when the abnormality log and the combination of the plurality of prediction abnormality logs only partially match. Therefore, it is more likely that the attack reception can be determined more reliably.

### (2) Operation of Log Determination Device

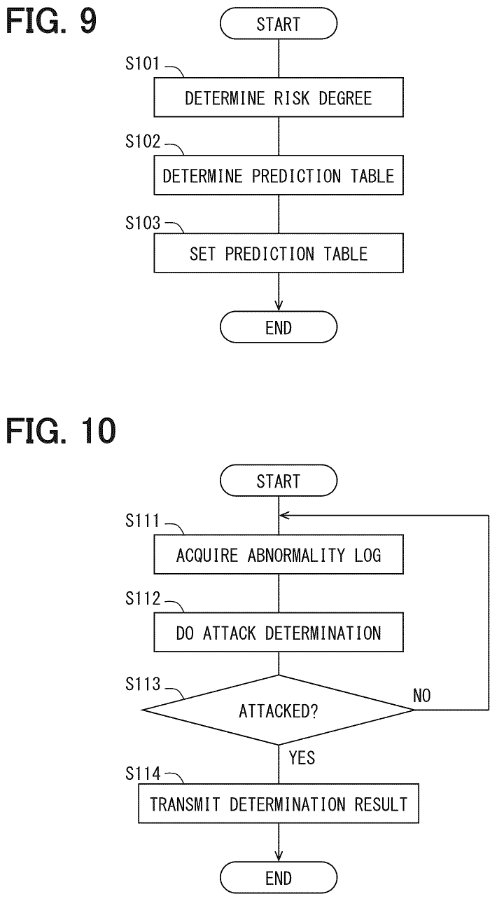

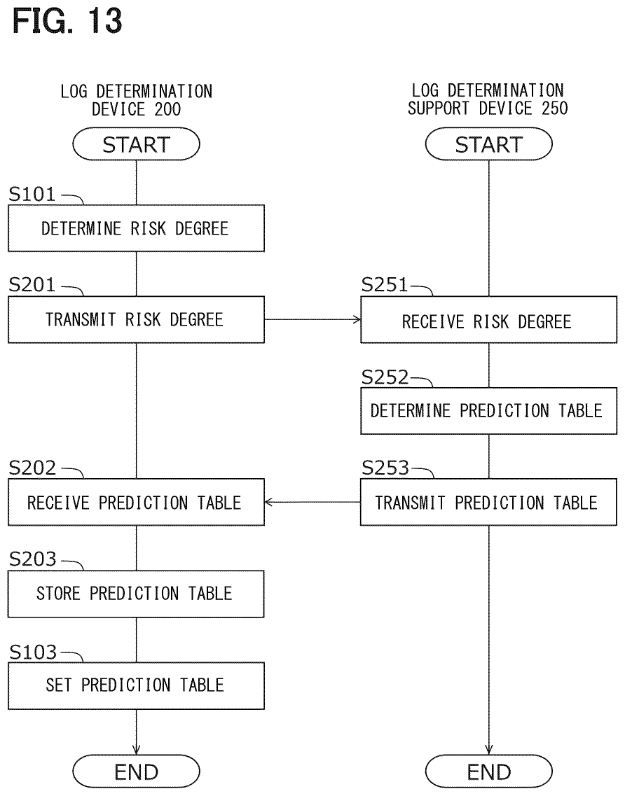

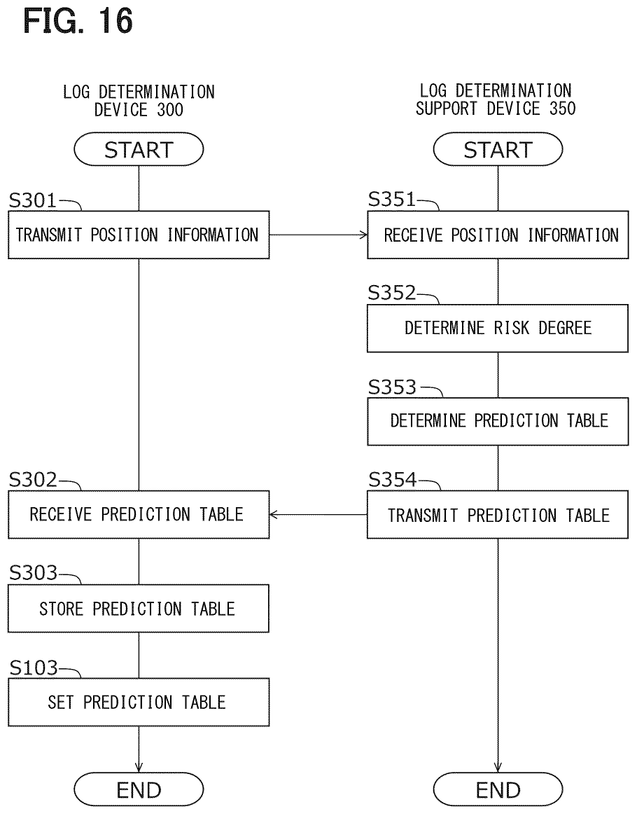

Next, the operation of the log determination device 100 will be described with reference to FIGS. 9 and 10. FIG. 9 and FIG. 10 show not only the log determination method executed by the log determination device 100, but also the processing procedure of the log determination program executable by the log determination device 100. These processes are not limited to the order shown in FIG. 9 and FIG. 10. That is, unless there is a restriction such as a relationship in which a step uses a result of the previous step, the order may be reversed. The same applies to FIG. 13 and FIG. 16 of the other embodiments, which will be described later.

FIG. 9 is a diagram illustrating the operation related to setting the determination criterion used by the attack determination unit 108. Although FIG. 9 illustrates the example in which the determination criterion is the prediction table, as described above, the determination criterion is not limited to the prediction table.

The risk determination unit 102 determines the attack reception risk of the electronic control system S (S101). The determination criterion setting unit 103 determines the prediction table that is the determination criterion for determining whether the electronic control system S has been attacked, based on the risk degree (S102). The determination criterion setting unit 103 sets the prediction table used by the attack determination unit 108 to the prediction table determined in S102 (S103).

Next, with reference to FIG. 10, operations related to attack determination in the log determination device 100 will be described. The log acquisition unit 104 acquires the abnormality log generated by the security sensor when the security sensor included in each ECU 10 of the electronic control system S detects the abnormality (S111). The attack determination unit 108 determines whether the electronic control system S has been attacked using the determination criterion set in S103 of FIG. 9 and the abnormality log acquired in S111 (S112). Here, when the attack determination unit 108 determines that the attack has been received (S113: Y), the determination result transmitter 109 transmits the determination result by the attack determination unit 108 to the external device 20 (S114).

### (3) Short Overview

As described above, according to the present embodiment, it is possible to set the determination criterion for determining whether the electronic control system mounted on the vehicle is attacked based on the risk degree of cyberattack reception. Thereby, when the risk degree is high, it is possible to increase the possibility of detecting the attack based on the abnormality log and prevent the attack from being overlooked.

### 3. Modification

### (1) First Modification

In the first embodiment, a configuration has been described in which the attack determination unit 108 performs attack determination using the prediction table. However, the attack determination unit 108 may determine whether the electronic control system S has received the attack using another method without using the prediction table.

For example, the attack determination unit 108 may determine that the attack has been received when the number of times the security sensor has detected the abnormality is equal to or greater than a threshold value. In this case, the determination criterion setting unit 103 determines the threshold value of the number of times the security sensor has detected the abnormality as the determination criterion, based on the risk degree.

Specifically, when the risk degree is high (corresponding to the “first risk degree”), the determination criterion setting unit 103 determines and sets the threshold, which is the determination criterion, so that a threshold for the number of abnormality detection is lower than when the risk degree is low (corresponding to the “second risk degree”).

For example, the threshold value is set to 10 in an area with the high risk degree, the threshold value is set to 50 in an area with the medium risk degree, and the threshold value is set to 100 in an area with the low risk degree. In this case, when the number of times the security sensor has detected the abnormality is 30, the attack determination unit 108 does not determine that the attack has been received in the area with the low or medium risk degree, but determines that the attack has been received in the area with the high risk degree.

As another example, the attack determination unit 108 may determine that the attack has been received when the number of security sensors that have detected the abnormality is equal to or greater than a threshold value. In this case, the determination criterion setting unit 103 determines the threshold value of the number of security sensors that has detected the abnormality as the determination criterion, based on the risk degree.

Specifically, when the risk degree is high (corresponding to the “first risk degree”), the determination criterion setting unit 103 determines and sets the threshold, which is the determination criterion, so that a threshold for the number of security sensors that has detected the abnormality is lower than when the risk degree is low (corresponding to the “second risk degree”).

For example, the threshold value is set to 2 in an area with the high risk degree, the threshold value is set to 5 in an area with the medium risk degree, and the threshold value is set to 10 in an area with the low risk degree. In this case, when the number of the security sensor has detected the abnormality is 4, the attack determination unit 108 does not determine that the attack has been received in the area with the low risk degree, but determines that the attack has been received in the area with the medium or high risk degree.

In all of the above-described modifications, the determination criterion are set such that the higher the degree of risk, the lower the threshold value. Thereby, in any of the modified examples, the higher the risk degree, the easier it is for the attack determination unit 108 to detect the attack. It is possible to prevent the attack from being overlooked.

### (2) Second Modification

In the embodiments described above, the configuration has been described in which the determination criterion used by the attack determination unit 108 is set based on the risk degree. In the present modification, a configuration will be described in which other controls are performed based on the risk degree.

For example, the attack determination unit 108 may control the frequency with which the attack determination unit 103 determines whether the attack determination unit 103 has received the attack based on the risk degree determined by the risk determination unit 102. Specifically, the attack determination unit 108 performs control so that attack determination is performed more frequently when the risk degree is high compared to when the risk degree is low.

When the attack determination unit 108 periodically performs attack determination, the frequency of attack determination is increased by shortening the time period for performing the attack determination. Alternatively, when the attack determination unit 108 determines the attack each time the log acquisition unit 104 receives a predetermined number of abnormality logs or each time the vehicle travels a predetermined distance, the frequency of attack determination may be increased by decreasing or shortening the predetermined number or the predetermined distance.

The higher the risk degree, the higher the frequency with which the log determination device 100 performs the attack determination. Thereby, it is possible to immediately detect the attack when the electronic control system S receives the attack in the situation where the risk degree is high. Further, when the risk degree is low, it is possible to reduce the amount of CPU resource consumption of the log determination device 100 by lowering the frequency of attack determination compared to when the risk degree is high.

As another example, the memory controller 106 may control the amount of abnormality log data to be stored in the log storage 105 based on the risk degree determined by the risk determination unit 102. Specifically, the memory controller 106 controls the log storage 105 to store a larger amount of data in the abnormality log when the risk degree is high compared to when the risk degree is low.

In order to use the cyber attack analysis received by the electronic control system S for analysis, it is desirable to store the abnormality logs generated before and after the attack. By storing more abnormality logs, it is possible to analyze the cyber attack in more detail. Therefore, when the risk degree is high, the amount of abnormality log data stored in the log storage 105 is controlled to increase, and more abnormal logs are accumulated. Thereby, it is possible to prevent logs useful for analyzing cyber attacks from being discarded.

### (3) Third Modification

The present modification describes a configuration, in addition to determining whether the electronic control system S has received the attack, the attack determination unit 108 determines the attack “accuracy” as the degree of possibility that the electronic control system S has received the attack.

Here, the “accuracy” is sufficient as long as it indicates the degree of certainty that the attack has been received, and includes not only a case of indication with numerical values but also a case of indication with standardized values, symbols, or sets.

The attack determination unit 108 determines the attack probability based on, for example, the match rate between the abnormality log and the combination of the plurality of prediction abnormality logs included in the prediction table. As an example, the attack determination unit 108 determines that the accuracy is 100% when the match rate between the abnormality log and the combination of the plurality of prediction abnormal logs is 100%. The attack determination unit 108 determines that the accuracy is 70% when the match rate is 70%.

Note that the attack determination unit 108 can determine the attack probability using anything other than the match rate between the abnormality log and the combination of the plurality of prediction abnormality logs. For example, when performing the attack determination using the prediction table, the attack accuracy may be associated with each attack type included in the prediction table. In this case, the attack determination unit 108 can also determine the attack accuracy when determining the attack type. The attack types included in the prediction table include those for which the attack indicated by the attack type is highly likely to occur, and those for which the attack indicated by the attack type is lowly likely to occur. Therefore, even in a case where an abnormality log that completely matches the combination of prediction abnormality logs of attack type A1 is obtained, when the attack of attack type A1 itself is extremely rare, the attack reception possibility of attack type A1 is low. Therefore, as described above, the attack determination unit 108 may determine the attack accuracy by associating the attack accuracy with each attack type in advance and storing it in the prediction table.

Further, as in the first modification described above, even when the attack is determined using a threshold for the number of times the security sensor has detected the abnormality or a threshold for the number of security sensors that have detected the abnormality, the attack determination unit 108 may determine the attack accuracy. For example, the attack determination unit 108 determines the attack probability based on the ratio of the number of times the security sensor has detected the abnormality or the number of security sensors that has detected the abnormality to a threshold value.

Note that the attack accuracy may be expressed by a numerical value (for example, 70%, 100%, or the like) or by a symbol such as high, medium, or low.

In the present modification, the determination result transmitter 109 may transmit the attack accuracy determined by the attack determination unit 108 to the outside of the vehicle in addition to the determination result.

Note that although the case where the first to third modifications are applied to the first embodiment has been described as an example, each modification may be applied to the second or third embodiment described later.

### 4. Second Embodiment

The first embodiment has described the configuration in which the prediction table storage 107 of the log determination device 100 stores the plurality of prediction tables in advance, and the determination criterion setting unit 103 determines and sets one of the prediction tables from the plurality of prediction tables based on the risk degree. However, since the amount of data in the prediction table is large, when the prediction table storage 107 mounted on the vehicle stores the plurality of prediction tables, the capacity of the memory mounted on the vehicle is likely to be limited.

Therefore, in the present embodiment, a configuration will be described in which the log determination device mounted on a vehicle determines the risk degree, and a prediction table corresponding to the risk degree is acquired from the log determination support device located outside the vehicle.

### (1) Configuration of Log Determination Device 200

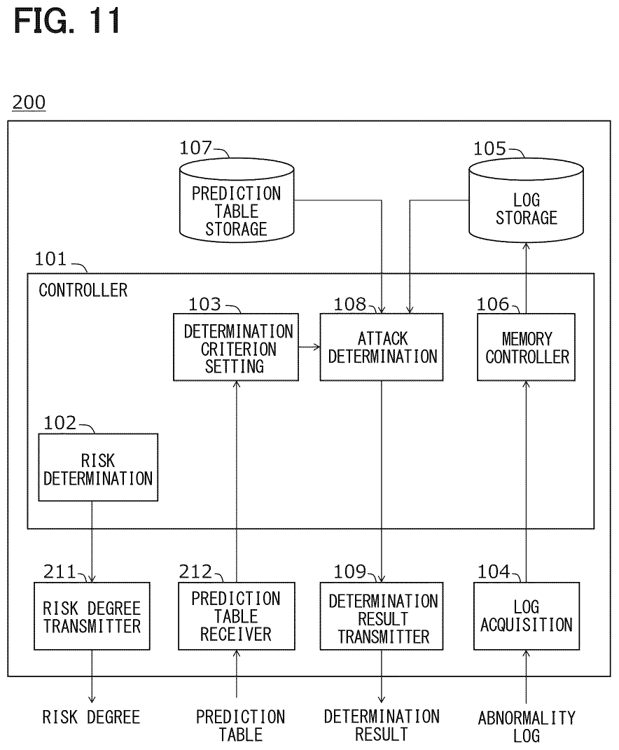

The configuration of the log determination device 200 according to the present embodiment will be described with reference to FIG. 11. The same components as the log determination device 100 of the first embodiment are given the same reference numerals as in FIG. 4, and the description of the first embodiment will be quoted. The log determination device 200 includes the controller 101, the log acquisition unit 104, the log storage 105, the prediction table storage 107, the determination result transmitter 109, a risk degree transmitter 211, and a prediction table receiver 212. The controller 101 implements a risk determination unit 102, a determination criterion setting unit 103, a memory controller 106, and an attack determination unit 108 using hardware and/or software.

The risk degree transmitter 211 transmits the risk determined by the risk determination unit 102 to the log determination support device 250, which is an external device. The prediction table receiver 212 (corresponding to a “determination criterion receiver”) receives the prediction table (corresponding to the “determination criterion”) transmitted from the log determination support device 250. The prediction table storage 107 stores the prediction table received by the prediction table receiver 212. The determination criterion setting unit 103 sets the prediction table received by the prediction table receiver 212 and stored in the prediction table storage 107 as the determination criterion for the attack determination unit 108.

### (2) Configuration of Log Determination Support Device 250

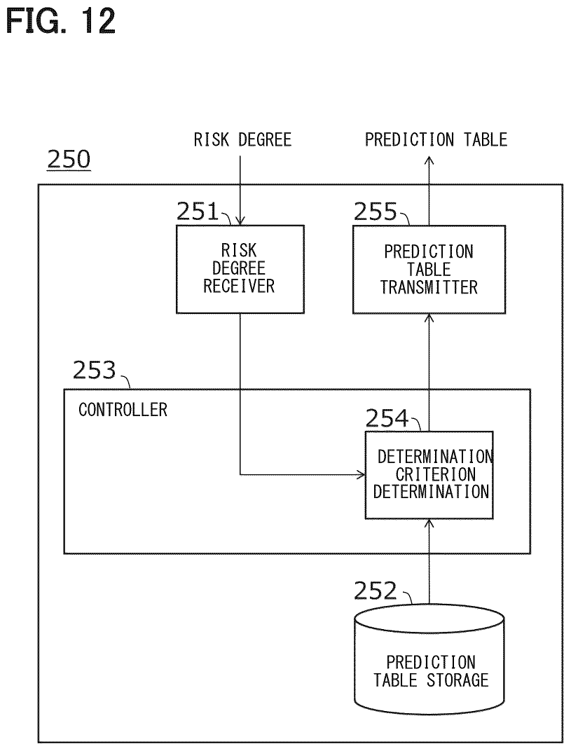

The configuration of the log determination support device 250 will be described with reference to FIG. 12. The log determination support device 250 includes a risk degree receiver 251, a prediction table storage 252, a controller 253, and a prediction table transmitter 255. The controller 253 implements a determination criterion determination unit 254 using hardware and/or software.

The risk receiver 251 receives the risk degree transmitted from the log determination device 200.

The prediction table storage 252 is a memory that stores a plurality of prediction tables depending on the risk degree. In the first embodiment, the prediction table storage 107 of the log determination device 100 stores the plurality of prediction tables, whereas in the present embodiment, the prediction table storage 252 of the log determination support device 250 stores the plurality of prediction tables.

The determination criterion determination unit 254 of the controller 235 determines, among the plurality of prediction tables stored by the prediction table storage 252, one prediction table corresponding to the risk degree received by the risk degree receiver 251 as the prediction table used by the log determination device 200 for attack determination, in other words, as the determination criterion.

The prediction table transmitter 255 transmits the prediction table determined by the determination criterion determination unit 254 to the log determination device 200.

### (3) Operation of Log Determination Device 200 and Log Determination Support Device 250

Next, the operations of the log determination device 200 and the log determination support device 250 will be described with reference to FIG. 13. Among the operations of the log determination device 200, the same operations as those of the log determination device 100 are given the same reference numerals as in FIG. 9.

The risk determination unit 102 determines the attack reception risk of the electronic control system S (S101). The risk degree transmitter 211 transmits the risk degree determined in S101 to the log determination support device 250 (S201).

The risk receiver 251 of the log determination support device 250 receives the risk degree transmitted from the log determination device 200 (S251). The determination criterion determination unit 254 determines the prediction table, which is the criterion used to determine whether the electronic control system S has been attacked, based on the risk degree received in S251 (S252). The prediction table transmitter 255 transmits the prediction table determined in S252 to the log determination device 200 (S253).

The prediction table receiver 212 of the log determination device 200 receives the prediction table transmitted in S253 (S202). The prediction table storage 107 stores the prediction table received in S202 (S203). Then, the determination criterion setting unit 103 sets the prediction table used by the attack determination unit 108 in the prediction table received in S202 and stored in S203 (S103).

Note that the series of operations for performing attack determination in the log determination device 200 of the present embodiment is the same as that of the log determination device 100 of the first embodiment.

In the embodiments described above, the case where the determination criterion is the prediction table has been described as the example. However, the determination criterion of the present embodiment is not limited to the prediction table, and the determination criterion described in the modification of the first embodiment may be employed.

### (4) Short Overview

As described above, according to the present embodiment, the log determination device 200, which is the in-vehicle device, can acquire the determination criterion necessary for attack determination based on the risk degree without storing the plurality of prediction tables in the memory of the log determination device 200. Thereby, it is possible to reduce the load on the log determination device 200.

### 5. Third Embodiment

The first embodiment has described the configuration in which the risk determination unit 102 of the log determination device 100 determines that the risk degree of attack reception by the electronic control system S based on the vehicle state and determines the determination criterion used for attack determination based on the determined risk degree. However, when the log determination device determines the risk degree, the log determination device takes a processing load. Further, as described in the second embodiment, since the amount of data in the prediction table is large, when the prediction table storage 107 mounted on the vehicle stores the plurality of prediction tables, the capacity of the memory mounted on the vehicle is likely to be limited.

Therefore, in the present embodiment, a configuration will be described in which the log determination support device, which is the external device located outside the vehicle, determines the risk degree, and a prediction table corresponding to the risk degree is used as the determination criterion.

### (1) Configuration of Log Determination Device 300

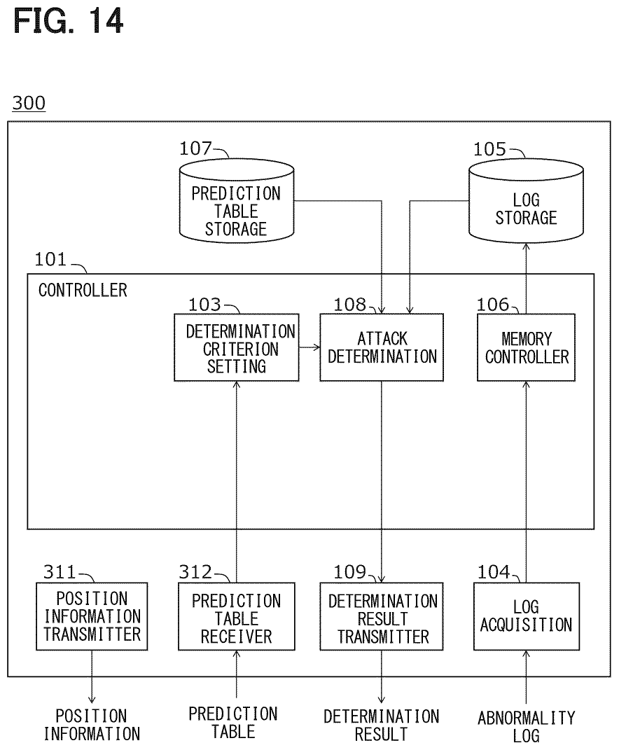

The configuration of the log determination device 300 according to the present embodiment will be described with reference to FIG. 14. The same components as the log determination device 100 of the first embodiment are given the same reference numerals as in FIG. 4, and the description of the first embodiment will be quoted.

The log determination device 300 includes the controller 101, the log acquisition unit 104, the log storage 105, the prediction table storage 107, the determination result transmitter 109, a position information transmitter 311, and a prediction table receiver 312. The controller 101 implements the determination criterion setting unit 103, a memory controller 106, and the attack determination unit 108 using hardware and/or software.

The location information transmitter 311 transmits the position information of the vehicle on which the log determination device 300 is mounted to the log determination support device 350. The position information transmitter 311 transmits, for example, vehicle position information acquired by a GPS (not shown) mounted on the vehicle. The position information transmitter 311 may transmit the vehicle location information periodically, or may transmit the vehicle position information every time the vehicle moves a predetermined distance.

Note that in the present embodiment, the log determination device 300 transmits the vehicle position information to the log determination support device 350. However, instead of or in addition to the vehicle position information, the log determination device 300 may transmit the vehicle information indicating the vehicle state to the log determination support device 350. The vehicle information is, for example, speed information of the vehicle and information indicating whether the vehicle is the automated driving vehicle.

The prediction table receiver 312 receives the prediction table transmitted from the log determination support device 350, which will be described later. The prediction table storage 107 stores the prediction table received by the prediction table receiver 312. Then, the determination criterion setting unit 103 sets the prediction table received by the prediction table receiver 312 and stored in the prediction table storage 107 as the determination criterion for the attack determination unit 108.

### (2) Configuration of Log Determination Support Device 350

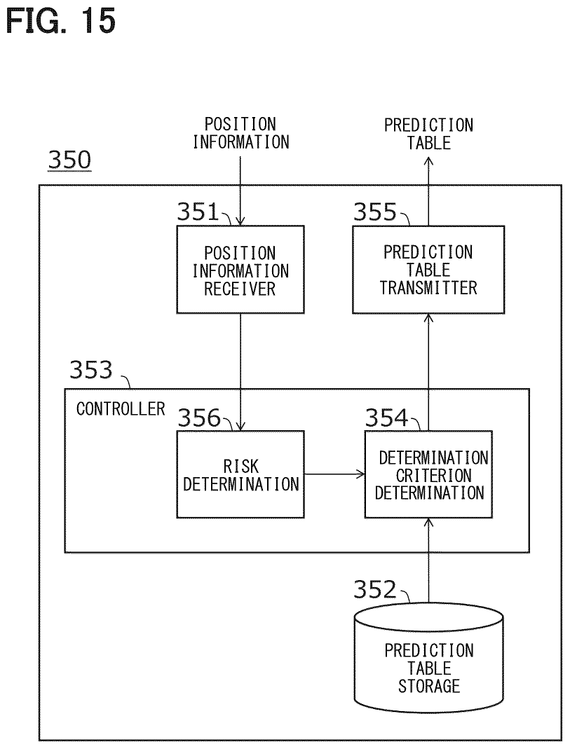

The configuration of the log determination support device 350 will be described with reference to FIG. 15. The log determination support device 350 includes a position information receiver 351, a prediction table storage 352, a controller 353, and a prediction table transmitter 355. The controller 353 implements a risk determination unit 356 and a determination criterion determination unit 354.

The position information receiver (corresponding to a “mobile object information receiver”) 351 receives the vehicle position information (corresponding to “mobile object information”) transmitted from the log determination device 200.

The prediction table storage 352 is a memory that stores a plurality of prediction tables depending on the risk degree. In the first embodiment, the prediction table storage 107 of the log determination device 100 stores the plurality of prediction tables, whereas in the present embodiment, the prediction table storage 352 of the log determination support device 350 stores the plurality of prediction tables.

The risk determination unit 356 of the controller 353 determines the risk degree that the electronic control system S mounted on the vehicle receives the attack, based on the vehicle position received by the position information receiver 351. Here, the risk determination unit 356 determines the risk based on the vehicle position using the similar method to in the first embodiment. For example, the risk determination unit 356 determines the risk using vehicle position information and a risk map. Note that, similarly to the first embodiment, the risk determination unit 356 may determine the risk degree based on vehicle information other than position information.

Based on the risk degree determined by the risk degree determination unit 356, the determination criterion determination unit 354 determines a determination criterion for attack determination by the log determination device 300. Specifically, among the plurality of prediction tables stored by the prediction table storage 352, one prediction table corresponding to the risk degree determined by the risk determination unit 356 is determined as the prediction table used by the log determination device 300 for attack determination, in other words, determined as the determination criterion.

The prediction table transmitter (corresponding to a “determination criterion transmitter”) 355 transmits the prediction table determined by the determination criterion determination unit 354 to the log determination device 300.

### (3) Operation of Log Determination Device 300 and Log Determination Support Device 350

Next, the operations of the log determination device 300 and the log determination support device 350 will be described with reference to FIG. 16. Among the operations of the log determination device 300, the same operations as those of the log determination device 100 are given the same reference numerals as in FIG. 9.

The location information transmitter 311 of the log determination device 300 transmits vehicle position information to the log determination support device 350 (S301).

The position information receiver 351 of the log determination support device 350 receives the vehicle position information transmitted in S301 (S351). The risk determination unit 356 determines the attack reception risk of the electronic control system S (S352). The determination criterion determination unit 354 determines the prediction table, which is the criterion used to determine whether the electronic control system S has been attacked in the log determination device 300, based on the risk degree determined in S352 (S353). The prediction table transmitter 355 transmits the prediction table determined in S353 to the log determination device 300 (S354).

The prediction table receiver 312 of the log determination device 300 receives the prediction table transmitted in S354 (S302). The prediction table storage 107 stores the prediction table received in S302 (S303). Then, the determination criterion setting unit 103 sets the prediction table used by the attack determination unit 108 in the prediction table received in S302 and stored in 303 (S103).

Note that the series of operations for performing attack determination in the log determination device 300 of the present embodiment is the same as that of the log determination device 100 of the first embodiment.

In the embodiments described above, the case where the determination criterion is the prediction table has been described as the example. However, the determination criterion of the present embodiment is not limited to the prediction table, and the determination criterion described in the modification of the first embodiment may be employed.

### (4) Short Overview

As described above, according to the present embodiment, the log determination support device 350 located outside the vehicle executes a process with a high processing load, such as determining the risk degree for setting the log determination criterion and determining the prediction table. Thereby, it is possible to reduce the load on the log determination device 300.

### (5) Modification of Third Embodiment

In the third embodiment described above, the log determination support device 350 determines the risk degree of the attack reception by the electronic control system S mounted on the same vehicle as the log determination device 300, based on the vehicle position information received from the log determination device 300. In contrast, in the present modification, the log determination support device transmits the prediction table corresponding to the risk degree of the area to the log determination device mounted on a vehicle existing in an area with a predetermined risk degree.

The configuration of the log determination device of the present modification is substantially the same as the log determination device of the third embodiment, and therefore will be described with reference to the log determination device 300 of the third embodiment. However, since the log determination device 300 of the present modification does not need to transmit the position information to the log determination support device, it does not necessarily need to include the location position transmitter 311.

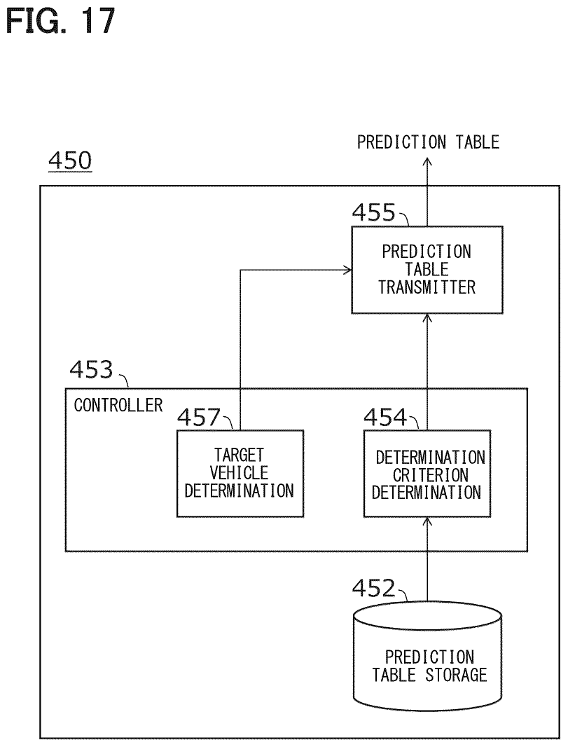

The configuration of the log determination support device 450 of the present modification will be described with reference to FIG. 17. The log determination support device 450 includes a prediction table storage 452, a controller 453, and a prediction table transmitter 455. The controller 453 implements a determination criterion determination unit 454 and a target vehicle determination unit 457.

Similar to the prediction table storage 451 of the second embodiment or the third embodiment, the prediction table storage 451 of this modification stores a plurality of prediction tables in advance according to the risk degree.

The determination criterion determination unit 454 of the controller 453 determines the prediction table that is the determination criterion used for attack determination of the log determination device 300 positioned in the specific area.

The target vehicle determination unit 457 determines, as the target vehicle, a vehicle that is located within the area using the prediction table determined by the determination criterion determination unit 454, among the vehicles equipped with the log determination device 300. Note that when the log determination support device 450 has acquired position information from the log determination device 300 mounted on the vehicle, the target vehicle determination unit 457 determines the target vehicle based on the received position information.

The prediction table transmitter 455 transmits the prediction table determined by the determination criterion determination unit 454 to the target vehicle determined by the target vehicle determination unit 457.

In addition, the example mentioned above has described the configuration in which the prediction table transmitter 455 transmits the prediction table to the target vehicle by unicast. However, the prediction table transmitter 455 of the present modification may transmit the prediction table to vehicles located within the specific area by broadcasting.

### 6. Overview

The features of the log determination device, the log determination support device, and the like in each embodiment of the present disclosure have been described above. Since terms used in the embodiments are examples, the terms may be replaced with synonymous terms or terms including synonymous functions.

The block diagrams used for the description of the embodiments are obtained by classifying and organizing the configurations of the devices for each function. The blocks representing the respective functions may be implemented by any combination of hardware or software. Since the blocks represent the functions, such a block diagram may also be understood as disclosures of a method and a program for implementing the method.

The order of the blocks that can be recognized as the processes, the flows, and the methods described in each embodiment may be changed unless there is a constraint such as a relationship in which one step uses a result of another step at the previous stage thereof.

The log determination device of each embodiment is a device for determining logs generated by a sensor of the electronic control system mounted on the vehicle. However, the log determination device of the present disclosure may apply to devices that determine logs generated by any electronic control system unless specific difficulties are caused. The log determination support device of each embodiment is a device for supporting log determination generated by the log determination device of the electronic control system mounted on the vehicle. However, the log determination support device of the present disclosure may apply to devices that support log determination by any log determination device unless specific difficulties are caused.

Further, examples of the form of the device of the present disclosure include a semiconductor element, an electronic circuit, a communication module, and a microcomputer. Examples of a form of a semi-finished product include an electric control unit (ECU) and a system board. Example of the security management device according to the present disclosure include a mobile router, a mobile phone, a smartphone, a tablet, a personal computer (PC), a workstation, and a server.

In addition, the devices may include a device having a communication function or the like, and examples thereof include a car navigation system.

Necessary functions such as an antenna or a communication interface may be added to each device.

The device can be implemented not only by dedicated hardware having the configurations and functions described in the embodiments, but also by a combination of a program, which is recorded on a recording medium such as a memory or a hard disk and is used for implementing the above configuration and features, and general-purpose hardware that has a dedicated or general-purpose CPU that can execute the program, a memory, and the like. A program is used for the log determination device or the log determination support device of the present disclosure. The program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the recording medium or from a server via a communication line without using the recording medium. Thereby, the latest functions can be provided at all times through program upgrade.

### INDUSTRIAL APPLICABILITY

The log determination device for a vehicle that is mainly an automobile and the log determination support device for supporting the log determination device according to the present disclosure have been described mainly. Alternatively, these may be applied to general mobile objects such as a motorcycle, a ship, a train, and an aircraft.

1. A log determination device mounted on a mobile object, the device comprising:
a risk determination unit configured to determine a risk degree of attack reception by an electronic control system mounted on the mobile object, based on a state of the mobile object;
a determination criterion setting unit configured to set a determination criterion that is a criterion for determining whether the electronic control system has received an attack;
a log acquisition unit configured to acquire an abnormality log generated by a sensor of the electronic control system when the sensor has detected an abnormality;
an attack determination unit configured to determine whether the electronic control system has received the attack using the determination criterion set by the determination criterion setting unit and the abnormality log; and
a determination result transmitter configured to transmit a determination result by the attack determination unit to an outside of the mobile object.

2. The log determination device according to claim 1, further comprising
a prediction table storage configured to store a prediction table indicating a correspondence relationship between a combination of a plurality of prediction abnormality logs and an attack type indicating a specific attack,
wherein
the plurality of prediction abnormality logs are predicted to be generated by the sensor when the electronic control system receives the specific attack, and
the attack determination unit is configured to determine whether the attack has been received using the prediction table.

3. The log determination device according to claim 2, wherein
the prediction table storage is configured to store a plurality of prediction tables according to the risk degree, and
the determination criterion setting unit is configured to determine and set one prediction table among the plurality of prediction tables as the determination criterion used by the attack determination unit.

4. The log determination device according to claim 3, wherein
the plurality of prediction tables include a first prediction table corresponding to a first risk degree and a second prediction table corresponding to a second risk lower than the first risk degree, and
a numerical number of the correspondence relationship in the first prediction table is more than a numerical number of the correspondence relationship in the second prediction table.

5. The log determination device according to claim 3, wherein
a numerical number of the plurality of prediction abnormality logs associated with one attack type in a first prediction table corresponding to a first risk degree among the plurality of prediction tables is less than a numerical number of the plurality of prediction abnormality logs associated with the one attack type in a second prediction table corresponding to a second risk degree lower than the first risk degree.

6. The log determination device according to claim 2, wherein
the attack determination unit is configured to determine that the electronic control system has received the attack when a match rate between the abnormality log and the combination of the plurality of prediction abnormality logs is equal to or higher than a threshold, and
the determination criterion setting unit is configured to set the threshold that is the determination criterion and lower when the risk degree is a first risk degree than the threshold set when the risk degree is a second risk degree.

7. The log determination device according to claim 1, wherein
the attack determination unit determines that the electronic control system has received the attack when a numerical number of times the sensor has detected the abnormality is equal to or greater than a threshold, and
the determination criterion setting unit sets the threshold that is the determination criterion and lower when the risk degree is a first risk degree than the threshold set when the risk degree is a second risk degree.

8. The log determination device according to claim 1, wherein
the attack determination unit determines that the electronic control system has received the attack when a numerical number of the sensor that have detected the abnormality is equal to or greater than a threshold, and
the determination criterion setting unit sets the threshold that is the determination criterion and lower when the risk degree is a first risk degree than the threshold set when the risk degree is a second risk degree.

9. The log determination device according to claim 1, wherein
the attack determination unit controls a frequency with which the attack determination unit determines whether the attack has been received based on the risk degree.

10. The log determination device according to claim 1, further comprising:
a log storage configured to store the abnormality log acquired by the log acquisition unit; and
a memory controller configured to control a data amount of the abnormality log to be stored in the log storage based on the risk degree.

11. The log determination device according to claim 1, wherein
the risk determination unit is configured to determine the risk degree based on a position of the mobile object.

12. The log determination device according to claim 1, wherein
the risk determination unit is configured to determine the risk degree based on a movement speed of the mobile object.

13. The log determination device according to claim 1, wherein
the mobile object is a vehicle, and
the risk determination unit is configured to determine the risk degree based on whether the vehicle is an automated driving vehicle.

14. The log determination device according to claim 1, wherein
the attack determination unit is further configured to calculate an accuracy of the attack reception by the electronic control system, and
the determination result transmitter is configured to output the accuracy in addition to the determination result.

15. The log determination device according to claim 1, wherein
the determination result transmitter transmits the determination result when the attack determination unit determines that the attack has been received.

16. The log determination device according to claim 1, further comprising:
a risk degree transmitter configured to transmit the risk degree determined by the risk determination unit to an external device located outside the mobile object; and
a determination criterion receiver configured to receive the determination criterion corresponding to the risk degree transmitted by the risk degree transmitter from the external device,
wherein
the criterion setting unit is configured to set the determination criterion used by the attack determination unit to the determination criterion received by the determination criterion receiver.

17. A log determination support device that is connected to a log determination device mounted on a mobile object and located outside the mobile object, the log determination support device comprising:
a mobile object information receiver configured to receive mobile object information indicating a state of the mobile object from the log determination device;
a risk determination unit configured to determine a risk degree of attack reception by an electronic control system mounted on the mobile object, based on the mobile object information;
a determination criterion determination unit configured to determine a determination criterion that is a criterion for determining whether the electronic control system has received an attack; and
a criterion transmitter configured to transmit the determination criterion determined by the criterion determination unit to the log determination device,
wherein
the log determination device determines whether the electronic control system has received the attack using the attack the determination criterion transmitted from the log determination support device and an abnormality log generated by a sensor of the electronic control system when the sensor has detected an abnormality log.

18. A log determination method executed by a log determination device mounted on a mobile object, the method comprising:
determining a risk degree of attack reception by an electronic control system mounted on the mobile object, based on a state of the mobile object;
setting a determination criterion that is a criterion for determining whether the electronic control system has received an attack;
acquiring an abnormality log generated by a sensor of the electronic control system when the sensor has detected an abnormality;
determining whether the electronic control system has received the attack using the set determination criterion and the abnormality log; and
transmitting a determination result of whether to have received an attack to an outside of the mobile object.

19. A non-transitory computer-readable storage medium storing a log determination program executable by a log determination device mounted on a mobile object, the program comprising:
determining a risk degree;
setting a determination criterion that is a criterion for determining whether an electronic control system has received an attack;
acquiring an abnormality log generated by a sensor of the electronic control system when the sensor has detected an abnormality;
determining whether the electronic control system has received the attack using the set determination criterion and the abnormality log; and
transmitting a determination result of whether to have received an attack to an outside of the mobile object.

20. A log determination support method executed by a log determination support device located outside a mobile object and connected to a log determination device mounted on the mobile object, the method comprising:
receiving mobile object information indicating a state of the mobile object from the log determination device;
determining a risk degree of attack reception by an electronic control system mounted on the mobile object, based on mobile object information;
determining a determination criterion that is a criterion for determining whether the electronic control system has received an attack; and
transmitting the determined determination criterion to the log determination device,
wherein
the log determination device determines whether the electronic control system has received the attack using the attack the determination criterion transmitted from the log determination support device and an abnormality log generated by a sensor of the electronic control system when the sensor has detected an abnormality log.

21. A non-transitory computer-readable storage medium storing a log determination support program executable by a log determination support device located outside a mobile object and connected to a log determination device mounted on the mobile object, the program comprising:
receiving mobile object information indicating a state of the mobile object from the log determination device;
determining a risk degree of attack reception by an electronic control system mounted on the mobile object, based on mobile object information;
determining a determination criterion that is a criterion for determining whether the electronic control system has received an attack; and
transmitting the determined determination criterion to the log determination device,
wherein
the log determination device determines whether the electronic control system has received the attack using the attack the determination criterion transmitted from the log determination support device and an abnormality log generated by a sensor of the electronic control system when the sensor has detected an abnormality log.
